(19) United States
(12) Patent Application Publication
(10) Pub. No.: US 2013/0155738 A1
(43) Pub. Date: Jun. 20, 2013

(54) SYSTEM AND METHOD FOR CONTROLLING REACTIVE POWER IN A POWER CONVERSION SYSTEM

(71) Applicants: Kathleen Ann O'Brien, Niskayuna, NY (US); Robert William Delmerico, Clifton Park, NY (US)

(72) Inventors: Kathleen Ann O'Brien, Niskayuna, NY (US); Robert William Delmerico, Clifton Park, NY (US)

(73) Assignee: GENERAL ELECTRIC COMPANY, SCHENECTADY, NY (US)

(21) Appl. No.: 13/329,405

(22) Filed: Dec. 19, 2011

(51) Int. Cl. H02M 7/539

(52) U.S. Cl. 363/95

(57) ABSTRACT

A power conversion system includes a three-phase power converter electrically couplable to a photovoltaic power source for converting DC power to three-phase AC power; sensors for measuring voltage levels of the AC power at each phase; and a controller for generating and transmitting independent reactive power commands for each phase of the three-phase power converter based at least in part on the voltage levels and an existing voltage imbalance.

### BACKGROUND

The invention relates to a system and method for controlling reactive power in a power conversion system.

With the rising cost and scarcity of conventional energy sources and concerns about the environment, there is a significant interest in alternative energy sources such as solar power and wind power. Solar power generation uses photovoltaic sources to generate electricity from the sun. Multiple photovoltaic sources are electrically coupled to one another in such systems to generate electricity. The electricity is supplied to utilities via a power distribution network including a power grid.

In response to utility requirements, power conversion systems regulate the output voltage provided to the utilities. A reactive power command is typically calculated based on the difference between the actual output voltage and the required output voltage. However, in a three-phase power conversion system, there is often an unbalance in the output voltages at each phase as a result of different loads being connected at each phase.

Existing power conversion control systems typically compute the required output voltage based on a balanced power conversion system and ignore the unbalanced voltage condition. Voltage unbalances may lead to higher maintenance costs and under-capacity utilization of the three-phase equipment and components of the power conversion system.

Hence, there is a need for an improved system to address the aforementioned issues.

### BRIEF DESCRIPTION

In one embodiment, a power conversion system is provided. The power conversion system includes a three-phase power converter electrically couplable to a photovoltaic power source for converting DC power to three-phase AC power. The power conversion system also includes sensors for measuring voltage levels of the AC power at each phase. The power conversion system further includes a controller for generating and transmitting independent reactive power commands for each phase of the three-phase power converter based at least in part on the voltage levels and an existing voltage imbalance.

In another embodiment, a method for controlling reactive power in a power network is provided. The method includes converting DC power to three-phase AC power. The method further includes measuring voltage levels of the AC power at each phase. The method also includes generating independent reactive power commands for each phase of the three-phase power converter based at least in part on the voltage levels and an existing voltage imbalance. The method further includes transmitting the independent reactive power commands for each phase to the power converter for controlling the reactive power.

In yet another embodiment, a non-transitory computer-readable medium comprising computer-readable instructions of a computer program that, when executed by a processor, cause the processor to perform a method is provided. The method includes converting DC power to three-phase AC power. The method further includes measuring voltage levels of the AC power at each phase. The method also includes generating independent reactive power commands for each phase of the three-phase power converter based at least in part on the voltage levels and an existing voltage imbalance. The method further includes transmitting the independent reactive power commands for each phase to the power converter for controlling the reactive power.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram representation of a power conversion system including a controller for providing independent reactive power commands to the power conversion system in accordance with an embodiment of the invention.

FIG. 2 is a flow chart representing steps involved in a method for controlling reactive power in a power conversion system in accordance with an embodiment of the invention.

FIG. 3 is a flow chart representing steps involved in a method for controlling reactive power in a mode to maintain an existing voltage imbalance in a power conversion system in accordance with an embodiment of the invention.

FIG. 4 is a flow chart representing steps involved in a method for controlling reactive power in a mode to at least partially reduce an existing voltage imbalance in accordance with an embodiment of the invention.

FIG. 5 is a flow chart representing steps involved in a method for controlling reactive power during night time and cloud cover conditions in accordance with an embodiment of the invention.

FIG. 6 is a flow chart representing steps involved in a method for controlling reactive power during power network emergency conditions in accordance with an embodiment of the invention.

### DETAILED DESCRIPTION

Embodiments of the present invention include a system and method for controlling reactive power in a power network. The system includes a three-phase power converter electrically couplable to a photovoltaic power source for converting DC power to three-phase AC power. The three-phase AC power is transmitted to a power grid. The power conversion system includes a sensor electrically coupled between the power grid and the power converter that measures voltage levels of the AC power at each phase. The measured voltage levels are provided to a controller that generates independent reactive power commands for each phase of the three-phase power converter based at least in part on the voltage levels and an existing voltage imbalance between the three phases. The controller transmits the independent reactive power command to the three-phase power converter to maintain or reduce the voltage imbalance. As described herein, the term “voltage imbalance” is referred to as a magnitude imbalance and should not be considered otherwise.

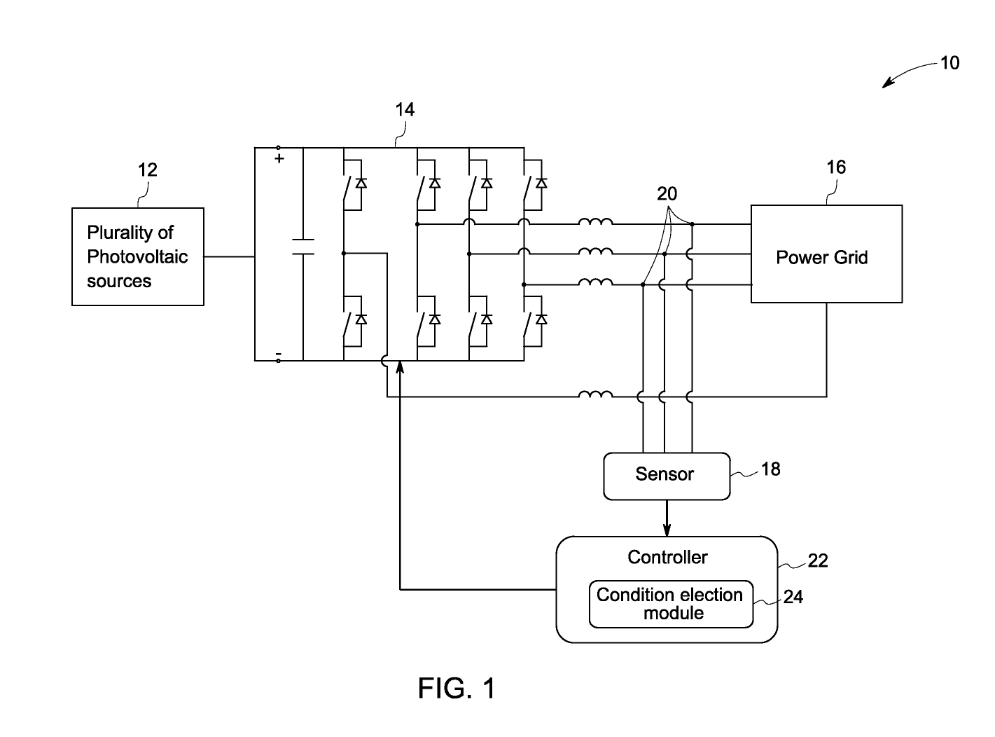

FIG. 1 is a block diagram representation of a power conversion system including a controller for providing independent reactive power commands to the power conversion system in accordance with an embodiment of the invention. The power conversion system 10 includes one or more photovoltaic sources 12 that generate direct current (DC) power from solar energy. The DC power is transferred to a power converter 14. The power converter 14 receives the DC power and converts the DC power to a three-phase AC power that is fed to a power grid 16. A voltage sensor 18 is electrically coupled between the power converter 14 and the power grid 16 to measure voltage levels of the AC power at each phase. In one embodiment, the sensor 18 is electrically coupled at a point of interconnection 20 to the power grid 16 in the power conversion system 10. The measured voltage levels are transferred to a controller 22 that generates independent reactive power commands for each phase of the three-phase power converter 14 based on the measured voltage levels and an existing voltage imbalance between the three phases. The independent reactive power commands are generated with an objective to balance a magnitude of a line voltage of each phase relative to a magnitude of a voltage at a neutral phase. In one embodiment, the line voltage of each phase of a four wire system is balanced by controlling the magnitude of the voltage at each phase. The three phases of the four wire system are coupled to the power grid 16 and the neutral phase is coupled to a neutral point in the power grid 16.

In one embodiment, the controller 22 further includes a condition election module 24 that may comprise a programmable module, an operator module or a combination of both. The condition election module 24 enables the controller 22 to operate at a selected one of a plurality of reactive power compensation modes.

Examples of reactive power compensation modes include a mode to maintain the existing voltage imbalance, a mode to at least partially reduce the existing voltage imbalance, and a mode to maintain or reduce the existing voltage imbalance only upon predetermined conditions. In a more specific embodiment, the predetermined conditions include night time, cloud cover, and a power network emergency conditions. In some embodiments, the night time and cloud cover conditions may more specifically include a condition in which the power converter 14 has excess operating capacity which in one embodiment is defined as a difference between a rated power and an actual operating power of the power converter. The power network emergency condition may include a condition of the existing voltage imbalance rising above a threshold voltage imbalance.

The controller 22 receives the measured voltage levels of each of the phases and computes the voltage imbalance in the power network based on the selected operating mode. In one embodiment, the controller may select the operating mode automatically or selects a mode based on an operator command. The controller 22 generates the independent reactive power commands for each of the phases and transmits the independent reactive power commands to the three-phase power converter 14. The independent reactive power commands allow the power converter 14 to generate reactive power to mitigate the voltage imbalance according to the selected operating mode. Several non-limiting examples of converters for which such control is useful include center-tapped power converters, a three-phase four leg power converters, and neutral point clamped power converters.

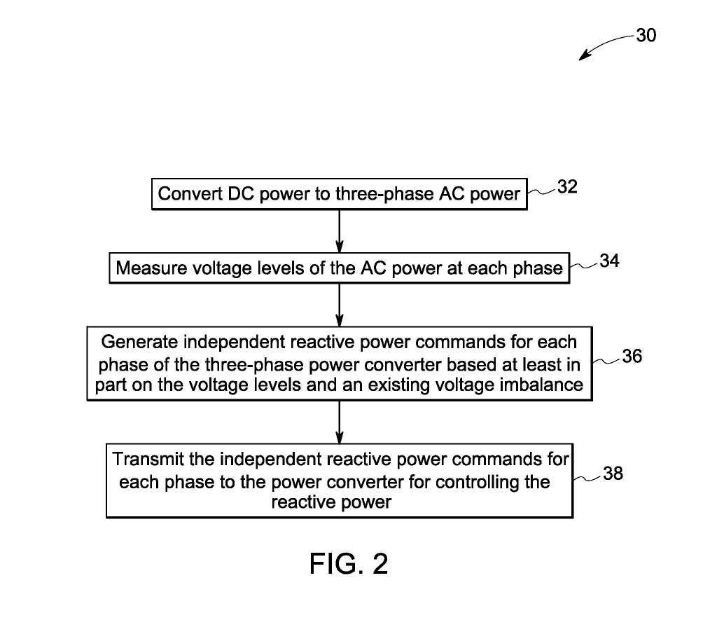

FIG. 2 is a flow chart representing steps involved in a method 30 for controlling reactive power in a power conversion system in accordance with an embodiment of the invention. The method 30 includes a step 32 for converting DC power to three-phase AC power. The voltage levels of the AC power at each phase are measured at step 34. Independent reactive power commands are generated for each phase of the three-phase power converter based at least in part on the voltage levels and an existing voltage imbalance in the power network in step 36. In one embodiment, the independent reactive power commands are generated by enabling selection among a plurality of reactive power compensation modes. In step 38, the independent reactive power commands for each phase are transmitted to the power converter for controlling the reactive power.

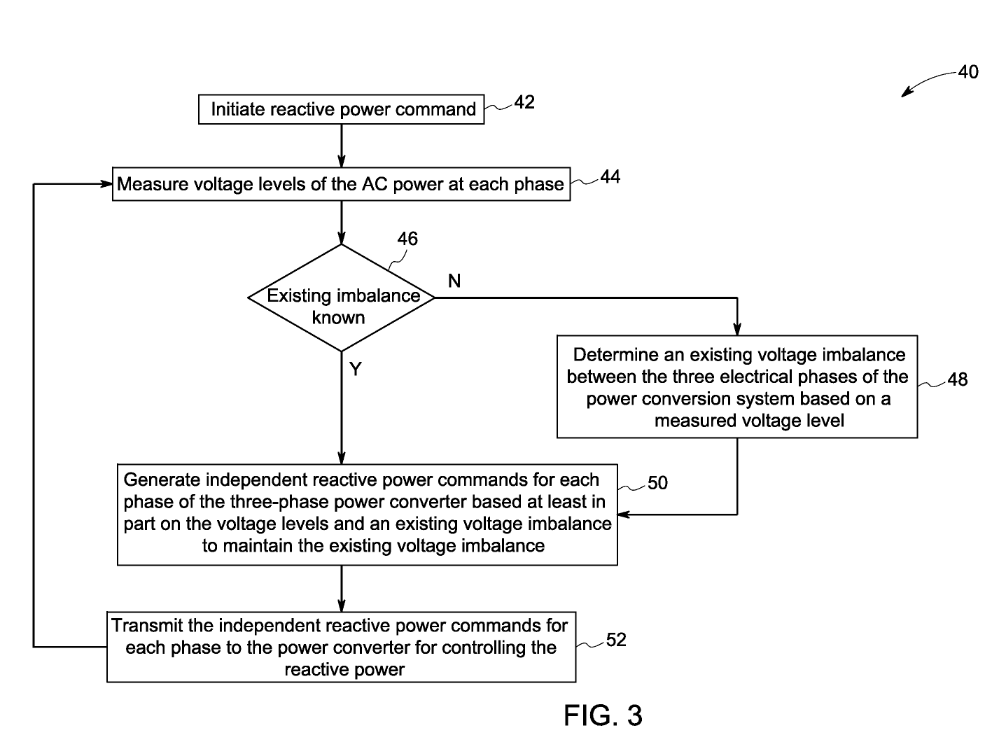

FIG. 3 is a flow chart representing the steps involved in a method 40 for controlling reactive power in a mode to maintain (and thereby not worsen) an existing voltage imbalance in a power conversion system in accordance with an embodiment of the invention. Initially, in step 42, a reactive power command is activated by an operator of the power grid. Then the voltage levels of the each of the three-phases in the power conversion system are measured in step 44. In step 46, the controller determines whether the existing voltage imbalance is already known. If the existing voltage imbalance is not known, the controller computes the existing voltage imbalance based on the measured voltage levels of each phase in step 48 before moving step 50. If the existing voltage imbalance is known, the controller directly moves to step 50 and generates the independent reactive power commands for the power converter such that the existing voltage imbalance is maintained by the power converter. The independent reactive power commands are then transmitted to the power converter in step 52 for execution.

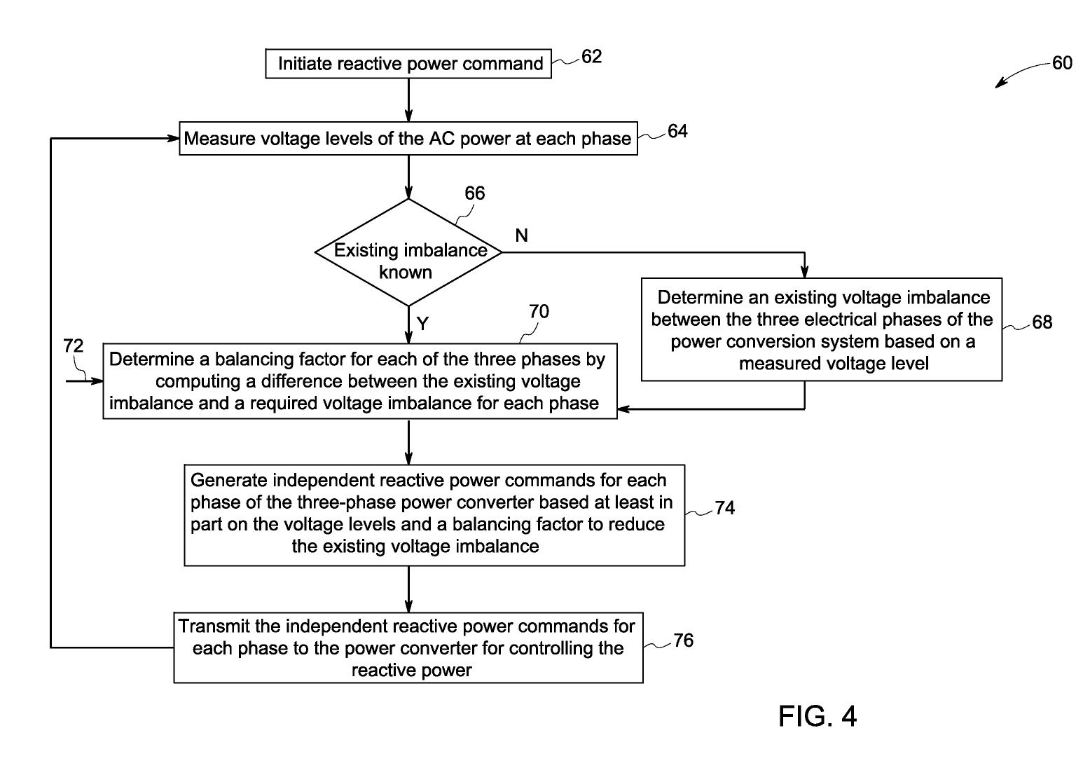

FIG. 4 is a flow chart representing steps involved in a method 60 for controlling reactive power in a mode to at least partially reduce an existing voltage imbalance in accordance with an embodiment of the invention. Steps 62, 64, 66, and 68 are similar to steps 42, 44, 46, 48 described with respect to FIG. 3. After the imbalance is either known or determined, at step 70, a balancing factor is determined for each of the three phases by computing a difference between the existing voltage imbalance and a required voltage imbalance 72. In one embodiment, the required voltage imbalance is a predetermined value provided by an external source to the controller. The controller in step 74 generates the independent reactive power commands for the power converter such that the existing voltage imbalance is reduced to the required voltage imbalance by the power converter. The independent reactive power commands are then transmitted to the power converter in step 76 for execution.

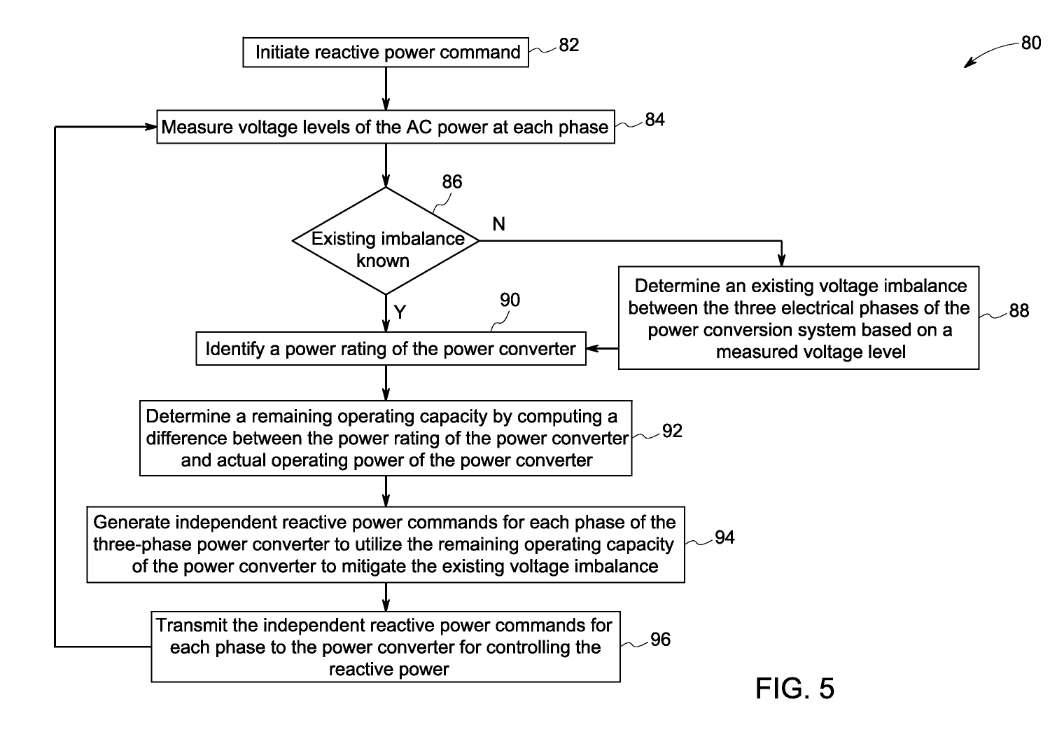

FIG. 5 is a flow chart representing steps involved in a method 80 for controlling reactive power during night time and cloud cover conditions in accordance with an embodiment of the invention. Steps 82, 84, 86, and 88 are similar to steps 42, 44, 46, 48 described with respect to FIG. 3. After the imbalance is either known or determined, at step 90, a power rating of the power converter is identified. The controller then determines the amount of excess operating capacity of the power converter by computing a difference between the power rating and an actual operating capacity of the power converter in step 92. In step 94, the controller generates the independent reactive power commands to utilize the excess operating capacity of the power converter to mitigate the existing voltage imbalance. Such independent reactive power commands are transmitted to the power converter in step 96 for execution.

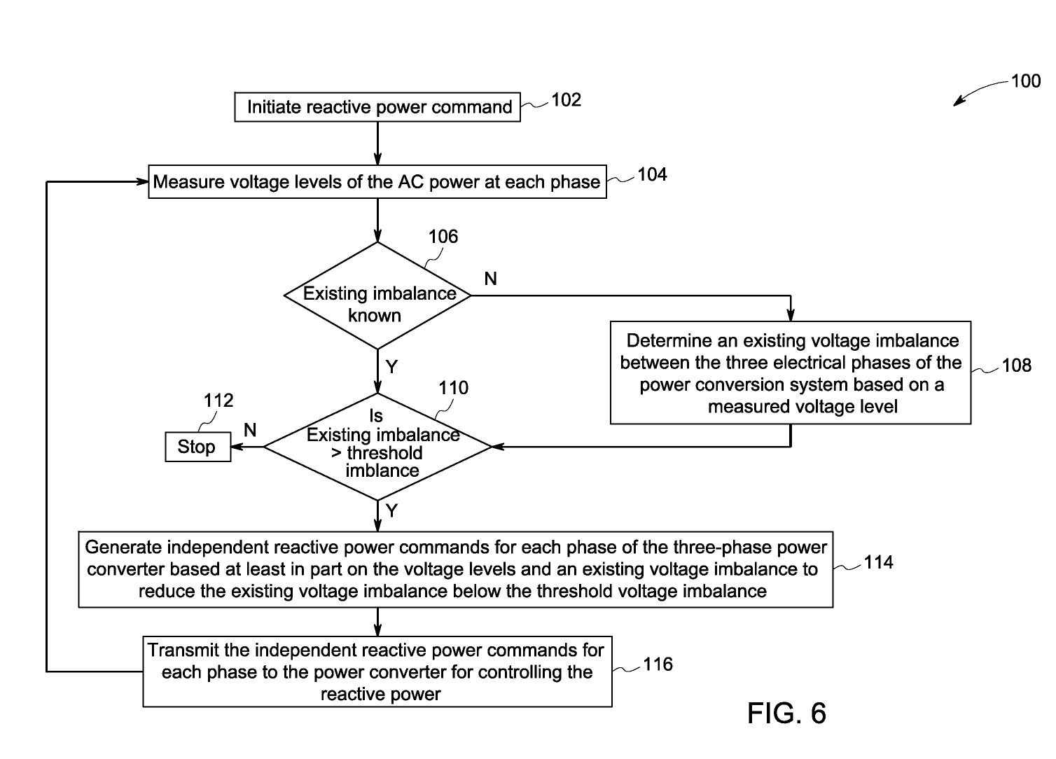

FIG. 6 is a flow chart representing steps involved in a method 100 for controlling reactive power in a predetermined condition including power network emergency condition in accordance with an embodiment of the invention. Steps 102, 104, 106, and 108 are similar to steps 42, 44, 46, 48 described with respect to FIG. 3. After the imbalance is either known or determined, at step 110, it is determined whether the existing imbalance is greater than a threshold imbalance. If the existing imbalance is within an acceptable range, no special control actions are taken. If the existing imbalance exceeds the threshold, then the controller in step 114 generates independent reactive power commands for the power converter such that the existing voltage imbalance is reduced to a level below the threshold voltage imbalance in the power conversion system. Such independent reactive power commands are transmitted to the power converter in step 116 for execution. The steps 104-116 are repeated continuously till the existing voltage imbalance is not reduced to a level below the threshold voltage imbalance.

The various embodiments of the system for controlling reactive power in a power network described above include sensors electrically coupled between a power converter and a power grid that measure a voltage level of each phase of the power conversion system. The sensors are electrically coupled to a controller that generates independent reactive power commands that control reactive power generation in the power conversion system to either maintain or reduce the existing voltage imbalance in the power network. The controller generates the independent reactive power commands for each of the phases of the three-phase power converter based on the existing voltage imbalance between each of the phases. This results in better efficiency and lower maintenance costs of the grid equipment and the utility.

It is to be understood that a skilled artisan will recognize the interchangeability of various features from different embodiments and that the various features described, as well as other known equivalents for each feature, may be mixed and matched by one of ordinary skill in this art to construct additional systems and techniques in accordance with principles of this disclosure. It is, therefore, to be understood that the appended claims are intended to cover all such modifications and changes as fall within the true spirit of the invention.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A power conversion system comprising:
a three-phase power converter electrically couplable to a photovoltaic power source for converting DC power to three-phase AC power;
sensors for measuring voltage levels of the AC power at each phase; and
a controller for generating and transmitting independent reactive power commands for each phase of the three-phase power converter based at least in part on the voltage levels and an existing voltage imbalance.

2. The system of claim 1, wherein the controller further comprises a condition election module for enabling selection between a plurality of reactive power compensation modes.

3. The system of claim 2, wherein the condition election module comprises a programmable module, an operator controllable module, or a programmable and operator controllable module.

4. The system of claim 2, wherein the plurality of reactive power compensation mode comprises a mode to maintain the existing voltage imbalance, a mode to at least partially reduce the existing voltage imbalance, and a mode to maintain or reduce the existing voltage imbalance upon predetermined conditions.

5. The system of claim 4, wherein the predetermined conditions comprise night time conditions and cloud cover conditions.

6. The system of claim 5, wherein the night time and cloud cover conditions comprise conditions wherein the power converter has excess operating capacity.

7. The system of claim 6, wherein the excess operating capacity of the power converter comprises a difference between a rated power and an actual operating power of the power converter.

8. The system of claim 4, wherein the predetermined conditions comprise power network emergency conditions.

9. The system of claim 8, wherein the power network emergency conditions comprise the existing voltage imbalance rising above a threshold voltage imbalance.

10. The system of claim 1, wherein the sensors measure the voltage level at points of interconnection between the power converter and a power grid.

11. A method for controlling reactive power in a power network comprising:
converting DC power to three-phase AC power;
measuring voltage levels of the AC power at each phase;
generating independent reactive power commands for each phase of the three-phase power converter based at least in part on the voltage levels and an existing voltage imbalance; and
transmitting the independent reactive power commands for each phase to the power converter for controlling the reactive power.

12. The method of claim 11, further comprising, prior to generating the independent reactive power commands, selecting a reactive power compensation mode.

13. The method of claim 12, wherein selecting the reactive power mode comprises selecting from a mode to maintain the existing voltage imbalance, a mode to at least partially reduce the existing voltage imbalance, and a mode to maintain or reduce the existing voltage imbalance only upon predetermined conditions.

14. The method of claim 13, wherein, upon selection of the mode to at least partially reduce the existing voltage imbalance, the method further comprises, determining a balancing factor for each of the three phases for use when generating the independent reactive power commands.

15. The method of claim 13, wherein, upon selection of the mode to maintain or reduce the existing voltage imbalance upon predetermined conditions, the method further comprises determining whether the power converter has excess operating capacity.

16. The method of claim 13, wherein, upon selection of the mode to maintain or reduce the existing voltage imbalance only upon predetermined conditions, the method further comprises determining whether a power network emergency condition is occurring.

17. The method of claim 13, wherein , upon selection of the mode to maintain or reduce the existing voltage imbalance only upon predetermined conditions, the method further comprises determining whether the voltage imbalance rises above a threshold voltage imbalance.

18. A non-transitory computer-readable medium comprising computer-readable instructions of a computer program that, when executed by a processor, cause the processor to perform a method, the method comprising:
converting DC power to three-phase AC power;
measuring voltage levels of the AC power at each phase;
generating independent reactive power commands for each phase of the three-phase power converter based at least in part on the voltage levels and an existing voltage imbalance; and
transmitting the independent reactive power commands for each phase to the power converter for controlling the reactive power.
